(19) United States
(12) Patent Application Publication
(10) Pub. No.: US 2009/0067408 A1
(43) Pub. Date: Mar. 12, 2009

(54) CENTRALIZED CALL LOG AND METHOD THEREOF

(75) Inventors: Eva-Maria Leppainen, Lempaala (FI); Arto Leppisaari, Kangasala (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/854,411

(22) Filed: Sep. 12, 2007

(51) Int. Cl. G06F 15/16; H04J 3/06

(52) U.S. Cl. 370/350; 709/229

(57) ABSTRACT

The present invention relates to a method and system thereof, which comprises a communication network having at least a serving session network node, through which communication initiation requests of the communication network are routed. The system further comprises an application services providing network node, which interfaces with the serving session network node. The application services providing network node is configured for providing functions related to a group of several terminal devices of one user. A communication initiation request is addressed to the user on the basis of a user related identifier associated with the group of several terminal devices and comprised by the communication initiation request. A protocol network node is configured for registering protocol information about a communication session upon reception of a detection signalization indicating the communication initiation request to the user having the corresponding service available.

### FIELD OF THE INVENTION

The present invention relates to communication systems. In particular, the present invention relates to communication systems supporting the use of multiple terminal devices by an individual user. More particularly, the present invention relates to communication systems enabled for collecting, storing and synchronizing communication request and communication session related information.

### BACKGROUND

More and more users of communication enabled terminal devices possess and make use of several communication terminal devices, each of which having individual properties provide user desired usability in different situations. For instance, a smart phone, communicator or communication enabled PDA has the required usability during working hours, whereas a small sized communication terminal device may be preferred during a favorite pastime.

In the near future, it is expected that the number of communication enabled devices used by users at the same time or alternatively in time will increase. Converged messaging addresses the user requirement to enable addressing of a group of communication terminal devices by, for instance, one public user address. In general, the use of several public user addresses may be possible. A call terminating at communication terminal devices handled as a group by a converged messaging service may be routed to one of the communication terminal devices thereof in accordance with predefined routing criteria. But call protocol registration performed individually at each communication terminal device may be cumbersome and lacks the required usability expected by the users.

### SUMMARY

According to an exemplary aspect of the present invention, a system is provided, which comprises a communication network having at least a serving session network node, through which communication initiation requests of the communication network are routed. The system further comprises an application services providing network node, which interfaces with the serving session network node. The application services providing network node is configured for providing functions related to a group of several terminal devices of one user. A communication initiation request is addressed to the user on the basis of a user related identifier associated with the group of several terminal devices and comprised by the communication initiation request. A protocol network node is configured for registering protocol information about a communication session upon reception of a detection signalization indicating the communication initiation request to the user having the corresponding service available. The protocol network node and the application service providing network node functions may co-exist in the same physical node.

According to an exemplary embodiment of the present invention, the serving session network node is a serving session server located within a session signaling protocol based network and in particular a serving call session control function (S-CSCF) in a session initiation protocol (SIP) based network such as an IP multimedia subsystem (IMS).

According to an exemplary embodiment of the present invention, the application services providing network node executes and hosts application services and interfaces with the serving session network node. In particular, the application services providing network node is an application server, which interfaces with the serving call session control function (S-CSCF) within the IP multimedia subsystem (IMS) using session initiation protocol.

According to an exemplary embodiment of the present invention, the protocol network node is implemented as call session logging services, which may be realized on the basis of Open Mobile Alliance (OMA) service architecture (OSE) environment. The protocol network node can be implemented as a call log XDM server, which may be one server of the shared XDM servers or a part of a message and media storage element in the Open Mobile Alliance (OMA) service architecture (OSE) or co-located with converged messaging services such as a converged IP messaging (CPM) server/enabler.

According to an exemplary embodiment of the present invention, the application services providing network node is configured for detecting the communication initiation and issuing the detection signalization to the protocol network node.

According to an exemplary embodiment of the present invention, the application services providing network node is configured for providing multi-terminal communication management on the basis of communication routing criteria. In particular, the application services providing network node is a converged messaging services network node offering and supporting converged messaging services. More particularly, the application services providing network node implements converged messaging services for instance on the basis of Open Mobile Alliance (OMA) service architecture (OSE) environment. The application services providing network node can be implemented as a converged IP messaging (CPM) server/enabler, which may be one server of the shared servers or a part of a message and media storage element in the Open Mobile Alliance (OMA) service architecture (OSE).

According to an exemplary embodiment of the present invention, the communication network supports a session signaling protocol supporting indication of initiation of communication session.

According to an exemplary embodiment of the present invention, the communication network supports session initiation protocol (SIP) and the establishment of communications within the communication network may be based on session initiation protocol (SIP). More particularly, the communication initiation message may be a session invitation message.

According to an exemplary embodiment of the present invention, the application services providing network node is configured for issuing one or more individual communication initiation requests to one or more terminal devices out of the group upon receiving the communication initiation session invitation request comprising the user related identifier.

According to an exemplary embodiment of the present invention, the protocol network node is further configured for synchronizing protocol information with protocol information stored locally in at least one terminal device out of the group of several terminal devices.

According to an exemplary embodiment of the present invention, the protocol network node is further configured for notifying at least one terminal device out of the group of several terminal devices about changes to the protocol information.

According to an exemplary embodiment of the present invention, the protocol information comprises one or more information out of a group of information comprising event status information, date of the call session, time of the call session, duration of the call session, media used during the call session, transport services used during the call session, name of the calling party, address of the calling party, identifier of the calling party, group identifier of the calling parties, and group name.

According to an exemplary embodiment of the present invention, the user related identifier comprises at least one out of a group of identifiers including: any user related information, which in particular allows for identifying the user of the group of several terminal devices and on the basis of which filtering operations can be performed to detect messages comprising matching user related information; an identifier identifying the group of several terminal devices; an identifier identifying one terminal device out of the group of several terminal devices; and an identifier identifying an application service supporting multi-terminal communication management on the basis of communication routing criteria.

According to another exemplary aspect of the present invention, a method is provided, in which communication initiation requests are routed through a serving session network node of a communication network. Upon detection of a communication initiation request comprising a user related identifier (, which may, e.g., include a user identifier and/or an identifier of an application services providing the protocol information registering) the protocol network node visit is triggered and protocol information about a communication session initiated by the communication initiation request is registered at the protocol network node. The protocol network node interfaces with the serving session network node. The communication initiation request is routed to an application services providing network node for providing functions related to the group of several terminal devices.

According to an exemplary embodiment of the present invention, preconfigured filter criteria are provided and the one or more of the preconfigured filter criteria are compared with the user related identifier. A matching communication initiation request is detected in case at least one or more of the preconfigured filter criteria match with the user related identifier.

According to another exemplary aspect of the present invention, a computer program product is provided, which comprises a computer readable medium including instructions which when carried out on a processor, cause the operations of routing communication initiation requests through a serving session network node of a communication network. The serving session network node interfaces with an application services providing network node and a protocol network node. The instructions further cause upon detecting that a communication initiation request comprises a user related identifier associated with a group of several terminal devices of a user, registering of protocol information about a communication session at the protocol network node, and routing the communication invitation request to the application services providing network node such that functions related to the group of several terminal devices can be provided thereat.

According to another exemplary aspect of the present invention, a method is provided, in which information about a call session is registered at a protocol network node upon detecting a communication initiation request, which comprises user related identification information matching with (pre-)defined filter criteria for requiring information logging at the protocol network node. The communication initiation request is routed through a serving session network node of a communication network. An application services providing network node and a protocol network node interface with the serving session network node.

The communication initiation request is routed to the application services providing network node, which is configured for providing functions related to the group of several terminal devices.

According to another exemplary aspect of the present invention, an apparatus is provided, which is configured for registering information about a communication session upon detection of a communication initiation request, which comprises a user related identifier associated with a group of several terminal devices of a user. The communication initiation request is routed through a serving session network node of a communication network. An application services providing network node and a protocol network node interface with the serving session network node. The communication initiation request is routed to the application services providing network node, which is configured for providing functions related to the group of several terminal devices.

### BRIEF DESCRIPTION OF THE DRAWINGS

These and other additional objects and features of the present invention will become readily apparent when the same are set forth in greater detail in the accompanying detailed description of the embodiments with reference being made to the drawings in which like reference numerals represent like or similar parts throughout and in which:

FIG. 1 depicts schematically a block diagram of a core network according to exemplary embodiments of the present invention;

FIG. 2 depicts schematically block diagrams of an application server and information management framework according to exemplary embodiments of the present invention

FIG. 3 depicts schematically a block diagram of a generic communication network according to exemplary embodiments of the present invention

FIG. 4 depicts schematically a first signal flow diagram between network components of the network of FIG. 3 according to exemplary embodiments of the present invention;

FIG. 5 depicts schematically a second signal flow diagram between network components of the network of FIG. 3 according to exemplary embodiments of the present invention; and

FIG. 6 depicts schematically a third signal flow diagram between network components of the network of FIG. 3 according to exemplary embodiments of the present invention.

### DETAILED DESCRIPTION

Embodiments of the present invention are described below by the way of examples only. The following embodiments are described in sufficient detail to enable those skilled in the art to practice the invention, and it is to be understood that the embodiments may be combined, or that other embodiments may be utilized and that structural, logical, and electrical changes may be made without departing from the spirit and scope of the present invention. It should be noted that references to “an”, “one”, or “various” embodiments in this document are not necessarily to the same embodiment, and such references contemplate more than one embodiment.

Discussed herein, among other things, are an IP multimedia subsystem as a core network supporting Session Initiation Protocol (SIP) and IP multimedia communication in a general communication network and Open Mobile Alliance (OMA) service architecture (OSE) implementations. The present invention should be understood as not being limited to any of the aforementioned specific implementation details which are described for the sake of feasibility of the present invention. In the following, references will be given to the terms “call” and “call session”. It should be noted that the terms “call” and “call session” have substantially the same meaning in this application. Call, session, or call session should be understood as any communication session between at least two terminals, in which session text data, voice data, multimedia data, and the like are exchanged between them. A communication session in particular may include a messaging session such as instantaneous messaging, Push-to-Talk (PoC) one-to-one or one-to-many (half-duplex) session, Voice-over-IP (VoIP) session, video sharing session and the like and/or any combinations thereof.

The term “SIP client” is used to refer to a computer program that is configured to control a communication network node such that it is able to process SIP messages such as SIP invitation messages. The computing platform that the SIP client runs on is referred to as a host system, terminal system or terminal device. The communication network node either comprises the host/terminal system or is associated with the host/terminal system.

Typically, a mobile communication network may logically be divided into an access network such as a radio access network (RAN) and a core network. The core network entities typically include various control entities and gateways for enabling communication via a number of access networks and also for interfacing with one or more communication systems external to the mobile communication network, such as with other cellular systems and or fixed line communication systems. The IP multimedia subsystem (IMS), among other systems, is an IP protocol based sub network of the core network and may use the Session Initiation Protocol (SIP), which is an application layer control protocol defined by the Internet Engineering Task Force (IETF) for creating, modifying, and terminating sessions with one or more terminals participating in a communication session. Session Initiation Protocol (SIP) is defined in the document IETF RFC 3261 ‘SIP: Session Initiation Protocol”. Although, references are made to the Session Initiation Protocol (SIP) those skilled in the art will understand that the Session Initiation Protocol (SIP) merely represents an example embodiment of a general session signaling protocol, which may have the same or similar basic features and functionality. Moreover, any further development of the Session Initiation Protocol (SIP) should be understood as included in the exemplary embodiments of the present invention.

### IMS

A user connected to a Session Initiation Protocol (SIP) base communication system may communicate with various entities of the communication system based on Session Initiation Protocol (SIP) messages. Communication devices or users running certain applications on the communication devices are registered with the Session Initiation Protocol (SIP) backbone so that an invitation to a particular session can be delivered to these end points. The Session Initiation Protocol (SIP) provides a registration mechanism for devices and users and it applies mechanisms such as location servers and registrars to route the session invitations appropriately.

The IP multimedia subsystem (IMS) architecture can be considered to be logically split into three layers. At the bottom is the access network which provides connectivity. Above this is the IP multimedia subsystem (IMS) core framework, which provides security and call control and manages quality of service (QoS). Additionally, the IP multimedia subsystem (IMS) architecture may further comprise an IP multimedia subsystem (IMS) services framework, which supports applications that determine services provided to the users.

A functional separation is enabled by the layered design described above and IMS network nodes thereof have interface points to further network nodes based on the rules of IP connectivity using a base signaling protocol on the basis of SIP. The IMS network nodes are able to interface with other packet/circuit-switched networks through gateway network nodes thereby allowing legacy networks and supporting many services thereof.

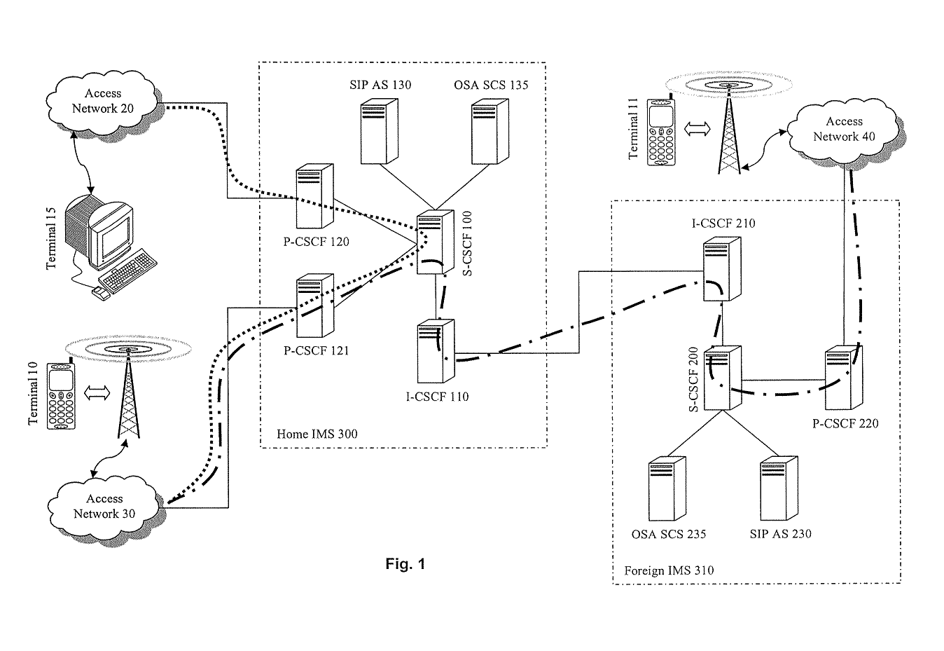

The basic IMS core architecture is schematically illustrated in FIG. 1, which represents a starting point for understanding operations and call flow in IMS networks.

Within the IMS Core there are signaling and control network nodes to control quality of service (QoS) and provide security and scalability. This is done primarily through the use of network server nodes that also offer security and encryption designated collectively as call session control function (CSCF). The proxy call session control function (P-CSCF) 121, 120, 220 provides the connectivity to the access networks and is considered a firewall between the core network and outside access.

The proxy call session control function (P-CSCF) 120, 121, 220 finds a route to the serving call session control function (S-CSCF) 100, 200, which provides the link to the services framework, through the interrogating call session control function (I-CSCF) 110, 210, which is similar in function to a redirect proxy. Connectivity to other types of networks including circuit-switched systems may be routed through media gateways (not shown).

The proxy call session control function (P-CSCF) 120, 121, 220 is an IMS network node that serves as the first contact point within the IMS core network layer. Functions of the proxy call session control function (P-CSCF) 120, 121, 220 include the forwarding of SIP messages received from a user terminal. These may be sent to the interrogating call session control function (I-CSCF) 110, 210 or serving call session control function (S-CSCF) 100, 200, depending on the type of message and procedure being carried out. The proxy call session control function (P-CSCF) 120, 121, 220 is also responsible for the generation of call detail records (CDR).

During registration, the proxy call session control function (P-CSCF) 120, 121, 220 receives the registration request and passes registration to the home domain interrogating call session control function (I-CSCF) 110, 210. The proxy call session control function (P-CSCF) 120, 121, 220 is then updated with the address of the serving call session control function (S-CSCF) 100, 200 for future messaging. During session establishment, the proxy call session control function (P-CSCF) 120, 121, 220 forwards messages directly to the appropriate serving call session control function (S-CSCF) 100, 200 whether in home or foreign networks. In particular, the tasks to be performed by the proxy call session control function (P-CSCF) 120, 121, 220 include, among other things, authenticating the endpoint terminal (also referred to as a user agent, which designates the endpoint participating in the SIP signaling; i.e. a user terminal or a server); finding other servers using a domain name system (DNS) or home subscriber server (HSS) query; routing SIP messages to correct servers; handling SIP messages routing headers; initiating SIP requests; replying redirect responses; and subscribing to registration at the serving call session control function (S-CSCF).

The interrogating call session control function (I-CSCF) 110, 210 is an IMS network node that provides a contact point within an operator's network allowing subscribers of that network operator or roaming subscribers to register. The interrogating call session control function (I-CSCF) 110, 210 deals will registration, routing, and forwarding of SIP messages and billing information. In particular, the tasks to be performed by the interrogating call session control function (I-CSCF) 110, 210, among other things, finding the serving call session control function (S-CSCF); routing SIP messages to correct servers; and handling SIP message routing headers.

The serving call session control function (S-CSCF) 100, 200 provides session control for subscribers accessing services within the IMS Core Network. The serving call session control function (S-CSCF) 100, 200 acts as a SIP server. It has responsibility for interacting with network databases such as the home subscriber server (HSS). As part of the SIP registration process a user will be allocated a serving call session control function (S-CSCF) 100, 200 to be responsible for all aspects of session control. The serving call session control function (S-CSCF) 100, 200 receives its initial registration request from the interrogating call session control function (I-CSCF). The serving call session control function (S-CSCF) 100, 200 then behaves as a SIP registrar (for instance as defined in IETF RFC 3261) and makes its information available through the home subscriber server (HSS), which acts as the location server. The serving call session control function (S-CSCF) 100, 200 receives the subscriber's service profile from the home subscriber server (HSS) during registration and caches the profile for subsequent use. The serving call session control function (S-CSCF) 100, 200 will then receive all subsequent SIP session-related and session unrelated messages on behalf of the customer's endpoint. In particular, the tasks to be performed by the serving call session control function (I-CSCF) 100, 200 include) among other things handling registration requests; supervising registration timers; terminating registrations; authenticating terminals; routing SIP messages to other servers or terminals; initiating SIP requests; performing telephone number mapping (ENUM) queries; maintaining session timers; and media policing: if media requirements are not allowed, rejecting the request.

The home subscriber server (HSS) (not shown) describes the many database functions that are required in mobile networks. These functions may include the home location register (HLR), domain name servers (DNS), access and authorization, as well as accounting, authorization and authentication (AAA). The home subscriber server (HSS) is a database for all the subscribers of an operator. It may be possible that each subscriber has multiple devices and identities. In particular, the tasks to be performed by the home subscriber server (HSS) include among other things responsibility for keeping a list of features and services associated with each user; providing selection of serving call session control function (S-CSCF) and application server (AS) for a user; storage of specific subscriber state data; and responsibility for access to the authentication database.

The application server (AS) 130, 230 may host and execute services, and interfaces with the serving call session control function (S-CSCF) using SIP. Examples of an application server (AS) include among other things an instant messaging function (IM server) or a presence function (PS server) or in a third Generation Partnership Project (3GPP) environment a voice call continuity function (VCC server), which enables handover between calls in an IMS and WLAN hotspots. Depending on the actual service, the application server (AS) may operate in SIP proxy mode, SIP user agent mode or SIP back-to-back user agent mode. An application server (AS) can be located in the home network or in an external third-party network. If located in the home network, it can query the home subscriber server (HSS).

The serving call session control function (S-CSCF) may be provided with further interfaces with for instance open services architecture (OSA) service capability server (SCS) 135, 235 enabling for services provided by servers external to an IMS.

As aforementioned, in the IP multimedia subsystem (IMS) different kinds of application servers are defined to realize services in the IP multimedia subsystem (IMS). For example, an open services architecture (OSA) service capability server (SCS) may be provided by network operators or third party service providers. The application servers are connected to the serving call session control function (S-CSCF) and the home subscriber server (HSS) in the IMS core network via the IP multimedia service control (ISC) interface supporting SIP connectivity. From the perspective of the serving call session control function (S-CSCF), any application server should exhibit the same interface behavior.

The Open Mobile Alliance (OMA) has introduced an OMA service environment (OSE), within which framework a set of capabilities of an SIP based IP core network such as the IP subsystem network (IMS) can be utilized for so-called enablers. In the OMA specifications, the interoperability and/or inter-working of OMA enablers realized on IMS with other OMA enablers (either IMS realized or not) are described. In particular, the interoperability between OMA service enabler implementations interfacing with an underlying IP multimedia subsystem is ensured. The possibility of an implementation of enablers meets user demands for various additional communication services.

From a functional point of view, the enabler interaction, in principle, can be split into layers, in this case named “SIP connectivity layer” and “enabler layer”. The SIP connectivity layer comprises the basic SIP proxy and registrar functions that allow end-to-end point connections based on addressing conventions using IMS session control functionality, as well as service-based routing. The IMS offers SIP infrastructure capabilities in the network and in the terminal and the SIP connectivity layer is common to all applications. So, the SIP connectivity layer functionally may not be developed for the individual service enablers.

The service enabler realizations using IMS are specific in the enabler layer on the top of the connectivity layer in the underlying network. The IMS connectivity layer looks completely transparent to the enabler layer even though there may be a need to define some service-specific routing rules inside the IMS connectivity layer. Such definitions may be seen as a part of the enabler configurations. At the enabler layer, it should not make a difference if the underlying infrastructure is IMS or some other similar network using a session signaling protocol such as SIP.

As aforementioned, the interaction is performed through an ISC interface. When the serving call session control function (S-CSCF) receives a SIP event from any user terminal, the decision at the serving call session control function (S-CSCF) to which application server associated with the serving call session control function (S-CSCF) the event should be sent may be made based on filter criteria information. The filter criteria to be applied may be centrally stored in the home subscriber server (HSS) as part of the user profile and downloaded to the serving call session control function (S-CSCF) upon user registration, or upon a terminating initial request for an unregistered user if unavailable. The filter criteria represent a provisioned subscription of a user to an application. After downloading user profile information including such filter criteria from the home subscriber service (HSS), the serving call session control function (S-CSCF) assesses the filter criteria. The filter criteria may be valid throughout the registration lifetime of a user or until the user profile information is changed.

Services offered to a subscriber of a communication system may comprise data synchronization. The synchronization services may allow for a fully compliant client and server data synchronization. Such full compliance may be achieved in combination with a synchronization protocol framework such as SyncML (Synchronization Markup Language) Data synchronization services may define and promote a set of universal specifications for symmetric data synchronization over networks and devices. Data may be synchronized between networked data with any mobile device or any user terminal with any networked data. The data synchronization protocol offered by the synchronization services may synchronize networked data with many different devices including for instance handheld computers, mobile phones, automotive computers, desktop PCs, and the like.

Other services offered to a subscriber of a communication system may comprise converged messaging services and in particular converged IP messaging services. Converged messaging services in general relates among other things to routing of calls addressing a user who has multiple terminal devices capable for receiving the call and who uses the multiple terminal devices simultaneously or alternatively in time. The multiple terminal devices may for instance include a mobile phone, a fixed phone, a personal digital assistant (PDA), a portable computer, and the like, each of which being enabled for communication through a communication system and in particular a SIP based communication system such as the aforementioned IMS core network. The converged messaging services may allow for instance the user of a multiple terminal devices to define call routing rules according to his personal preferences and/or the terminal device capabilities or status. Moreover, converged messaging services may further allow any caller who desires to initiate a call to the multiple terminal devices' user to use address information identifying the multiple terminal devices' user. The converged messaging services receiving the caller's initiation request may signal the incoming call to one of the multiple terminal devices for instance according to predefined routing rules or may signal the incoming call to all multiple terminal devices. Hence, the caller is relieved of the duty to direct the desired call to a specific terminal device, which the caller assumes to be currently carried with by the multiple terminal devices' user, and in case the multiple terminal devices' user does accepts the call, the caller is relieved of the duty to try to call the multiple terminal devices' user at another of the multiple terminal devices.

Beneath new opportunities and experiences of converged messaging services experienced by the user, resulting effects may contradict consumer habits. Typically, users have one terminal device, which is preferably used. Important information including contact information, calendar appointments, call protocol information etc is typically maintained at this user preferred terminal device with special diligence. When the user quite often changes among its multiple terminal devices for instance during a day or when the user simultaneously uses its several terminal devices, protocol information about terminating and/or originating calls (also referred to as call log information) differs among its multiple terminal devices. Therefore, the user may experience that the preferred terminal device may not store all important information as conventionally expected by the user. A terminal device to terminal device synchronization cannot overcome the aforementioned problem when the user wishes to have synchronized call protocol information in short term and one of its terminal devices is currently out of operation.

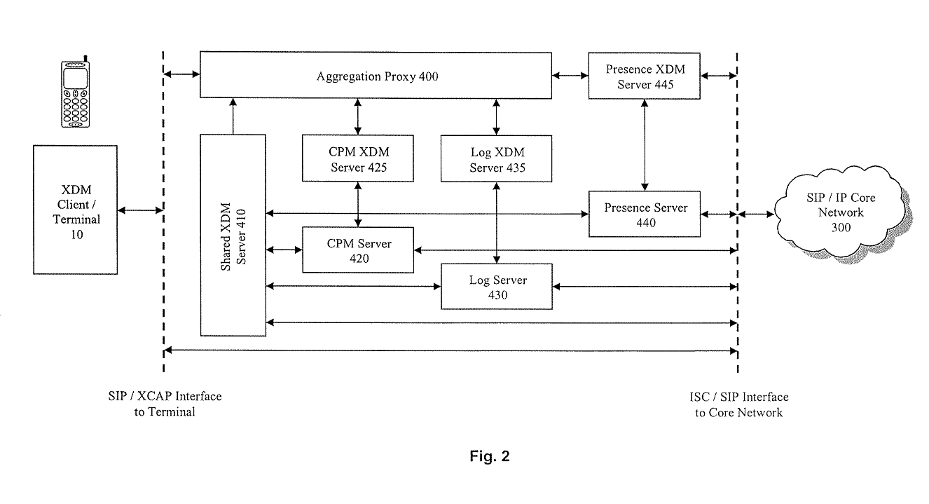

According to an exemplary embodiment of the present invention, the call protocol information should be generated and stored by networked logging services, which is arranged in the communication system at a location, and which enables the networked logging services to detect and monitor any terminating and/or originating calls of all the multiple terminal devices of the user. In particular, the exemplary embodiment of the present invention shown in FIG. 2 suggests an implementation of call session logging services on the basis of an OMA service environment (OSE) briefly described above.

The management and information architecture illustratively depicted in FIG. 2 for managing data either related to or used by application services in a communication system among other things refers to the enabler service framework as generally specified in “XML Document Management Architecture”, Version 1.0, 12. June 2006 (OMA-AD-XDM-V1_{—}2006_{—}06_{—}12-A) by the Open Mobile Alliance (OMA).

Referring to FIG. 2, the management and information architecture may comprise at least one terminal device 10 having XDM client functionality. The XDM client is a service requester embedded in the terminal device 10 and the XDM client enables the terminal device 10 to access XDM servers either though an aggregation proxy using for instance hyper text transfer protocol (HTTP) or through the SIP/IP core network 300, which is a core network supporting SIP and IP multimedia depending on the functionality needed to be performed. The XDM client of the terminal device 10 can access and process among other things information about converged call services and the XDM client of the terminal device 10 can synchronize call protocol information stored at a terminal device with networked call protocol information.

The management and information architecture may further comprise a converged messaging server 420, a call log server 430, and a presence server 440, which may also be called service enablers. A converged messaging XDM server 425, a call log XDM server 435 and a presence XDM server 445 store service specific information, process incoming data manipulation requests and trigger notifications about changes in the stored information. A shared XDM server 410 stores service information, which is shared among several service enablers. According to an exemplary embodiment of the present invention, the call log XDM server may be one server of the shared XDM servers or a part of a message & media storage element in the OMA CPM architecture or co-located with the converged messaging server. The call log XDM server may be one server of the shared XDM servers, or an individual XDM server.

XML document management (XDM) refers to a generic framework for data management, which is for instance based on hypertext transfer protocol (HTTP) based extended markup language (XML) configuration access protocol (XCAP). The XDM be used to define a common mechanism that makes information accessible to the different servers or XDM clients in the network. In the network, the information may be located, accessed and manipulated, e.g. created, changed, and deleted, by authorized principles. A uniform resource identifier (URI) list may be shared between multiple enablers. For example, a principal may group together the multiple device terminals of a user or multiple addresses of a user. Such a uniform resource identifier (URI) list may be reused by a number of different enablers such as the converged messaging server 420, the call session logging server 430, and the presence server 440.

The converged messaging XDM server 425 may make use of shared access policy XML documents and the XML documents listing multiple addresses of a certain user. Each user may have one access policy document, which may be used for managing and controlling incoming communication initiation requests (or call session invitations). The access policy document or a corresponding other document comprising policies and/or preferences related to request handling may define a preference for routing the incoming calls to a preferred terminal device out of a group of terminal devices based on a type of call (i.e. voice call, voice over IP call, video call, message call, email call, multimedia call, and the like). The XML documents including a list of user's addresses and user's device's identifiers may be used to manage and control a group of terminal devices of the user. For the sake of simplicity, the aforementioned XML documents including a list of identifiers will be referred to as group configuration documents. The group configuration documents should not be understood as being limited to XML coding; other coding may be used likewise. The group configuration documents may further comprise associative tables, which may associate one or more user specific uniform resource identifiers (URIs) identifying a user of a group of terminal devices with device-specific uniform resource identifiers (URIs). A presence XDM server 445 included as an example embodiment of additional XDM servers, may comprise among other things authorization policy documents, which may be used to authorize users (also referred to as watchers) attempting to subscribe to presence information.

In general, uniform resource identifiers (URIs) are used to identify different types of actors in a SIP-controlled network. Typically a uniform resource identifier (URI) points to a registered user identity of an individual user. A uniform resource identifier (URI) may identify also services, such as a voicemail server or conference facility uniform resource identifier (URI), conferencing instances, such as chat rooms or voice-over-IP (VoIP) conferencing instances, or other types of resources. In addition, a uniform resource identifier (URI) may point to a resource list, which may be a list of individual uniform resource identifiers (URIs), or in other words, a group of uniform resource identifiers (URIs).

According to one example of the present invention, the terms user, end-user, user agent, subscriber, and resource all refer to an entity able to use services via a communication network. A user or user agent is typically an individual registered user identity. The term “end-user” may be used to denote a human user of the system. A subscriber or resource may refer to an individual user or to a group of users subscribing to a single subscription. The terms resource list and group define herein an entity having its own identifier, such as its own uniform resource identifier (URI), and include a number of entities each having a different identifier, such as a different uniform resource identifier (URI).

For instance, a uniform resource identifier (URI) referring to the identity of an end-user may have one of the following forms:
sip: terminal@domain.com
sip: mainsipserver
sip: 192.168.2.1@
sip: john.smith@domain.com
sip: +8832594375@domain.com; user=phone
tel: +49-123-4567-890
sip:callee@example.com; gr=urn:uuid:f81d4fae-7dec-11d0-a765-00a0c91e6bf6

It should be noted that the latter exemplary identifier may represent an identifier relating to a user agent and more particularly a globally routable user agent URI (GRUU). The specification of the globally routable user agent URI (GRUU) is currently under evaluation and can be obtained from the Internet Engineering Task Force (IETF, http://www.ietf.org/). One of the latest working documents is dated Jun. 25, 2007 and named draft-ietf-sip-gruu-14.txt.

In IMS core based communication networks, two different end-user identities, a public identifier (public ID) and a private identifier (private ID), are used. The public identifier is the identifier inputted by an end-user of the communication networks and used by the communication networks for routing the session invitation request (such as would be analogous to the MSISDN known in mobile communication networks). The latter private identifier is used as a communication network internal register identifier (and would be analogous to the IMSI). A uniform resource identifier as illustratively depicted below may be used as a public identifier:
sip: jolin.smith@domain.com; or
sip: +49-123-4567-890@domain.com; user=phone
tel: +49-123-4567-890

The private identifier is used for identifying and authenticating a subscriber. Correspondingly, the private identifier is not known to the subscriber.

Hence, a specific converged messaging service identifier (CPM URI), e.g. a public service identifier, may be provided, which allows a caller to address a call to the converged messaging services. More generally, it should be noted that any user related information included in the request can be used, on the basis of which routing to an application service in accordance with filter information is enabled. More particularly, the routing may be based on initial filter criteria, which may be configured for the user identified by the aforementioned user related information. In accordance with an exemplary embodiment of the present invention, all incoming and outgoing (session invitation/initiation) requests may be routed on the basis of configured initial filter criteria and logging of any information about all incoming and outgoing session requests is enabled. In this exemplary embodiment the initial filter criteria may be configured for indicating a routing when the user's public identifiers are included in the incoming and/or outgoing requests. By matching the user related information included in the request and the configured initial filter criteria, the visitation of the protocol application service may be triggered.

The converged messaging server 420 receives then an invitation request from the caller, retrieves the converged messaging policy and group configuration documents in accordance with the public service identifier identifying the converged messaging services for a group of terminal devices of the end-user to be called, and causes routing of the invitation request to one or more terminal devices of the end-user to be called according to the retrieved converged messaging policy and group configuration documents. Alternatively, an end-user uniform resource identifier (URI) may be used by the caller. The converged messaging services may monitor the uniform resource identifiers (URIs) included in any session invitation requests sent over the communication network and intercepts the session invitation request signaling in case the uniform resource identifier (URI) in a session invitation request is known to the converged messaging services. Moreover, an end-user specific identifier, which originally identifies an end-user, may be redefined as a service identifier to point to the converged messaging services. Hence, in analogy to the use of a public service identifier (URI), a session invitation request issued by a caller is directly routed to the converged messaging services and the converged messaging services then routes the invitation request to one or more terminal devices of the end-user to be called according to the user-specific device policy and group configuration documents. In the latter case, the converged messaging services are transparent to a caller.

The call session logging XDM server 425 may store call protocol policy documents and call protocol documents. Each user of the call session logging messaging services may have one call protocol policy document, which may be used for controlling the logging of communication protocol initiations (or call session invitations). The call protocol policy document may define a preference, which type of call and/or which information about the calls to be registered should be logged. The call protocol documents may be generated by the call logging server 430 in accordance with the call protocol policy documents. The protocol information registration functionality of the call session logging server 430 may be triggered by the converged messaging server 420 upon receiving a session initiation request thereat. The call session logging XDM server 425 may maintain one call protocol document for each device group of an end-user defined in the converged messaging group configuration document at the converged messaging XDM server 425. This means, the call protocol document generated from the call protocol information registered by the call session logging server comprises information about incoming and/or outgoing calls of terminal devices of a defined terminal device group of an end-user. The call protocol information of an incoming and/or outgoing call may comprise call event status information (including for instance call missed, call accepted, call redirected, etc), date of the call, time of the call, duration of the call, media used during the call session, transport services used during the call session, name of the calling party, address of the calling party, identifier of the calling party (e.g. uniform resource identifier of the calling party), and in case of a group call, group identifier (e.g. uniform resource identifier of the group), group name, and the like. The call protocol information may be registered by the call session logging server 430 as long as the information is obtainable by the call session logging server 430. The call session logging server 430 may register and analyze session invitation requests and/or session description messages.

The XDM client of the terminal device 10 may synchronize with the call session logging XDM server 435 maintaining the call protocol document of each respective terminal device group. The synchronization procedure may be initiated by the terminal device 10 or may be initiated by the call session logging XDM server 435 upon change of the information maintained thereat. The synchronization procedure may also be initiated time triggered, event triggered and/or any further basis.

The converged messaging group configuration documents may comprise associative tables, which associate one or more user specific uniform resource identifiers (URIs) identifying a user of a group of terminal devices with device-specific uniform resource identifiers (URIs). The terminal devices of the group may continuously synchronize with the call protocol document maintained at the call session logging XDM server 435. The XDM clients at the terminal devices of the terminal device group may use a notification functionality (SIP subscribe/notify), which notifies the subscribed terminal devices when changes to a call protocol document occur. The XDM clients at the terminal devices may define a notification expiry time or notification rate or period at which notifications are sent by the call session logging XDM server 435. Alternatively or additionally, the XDM clients at the terminal device may access the call session logging XDM server 435 using XML configuration access protocol (XCAP) implemented on the basis of hypertext transfer protocol (HTTP) or may reset the notification expiry time to immediately (or in short time) force notifications about changes on the call protocol document.

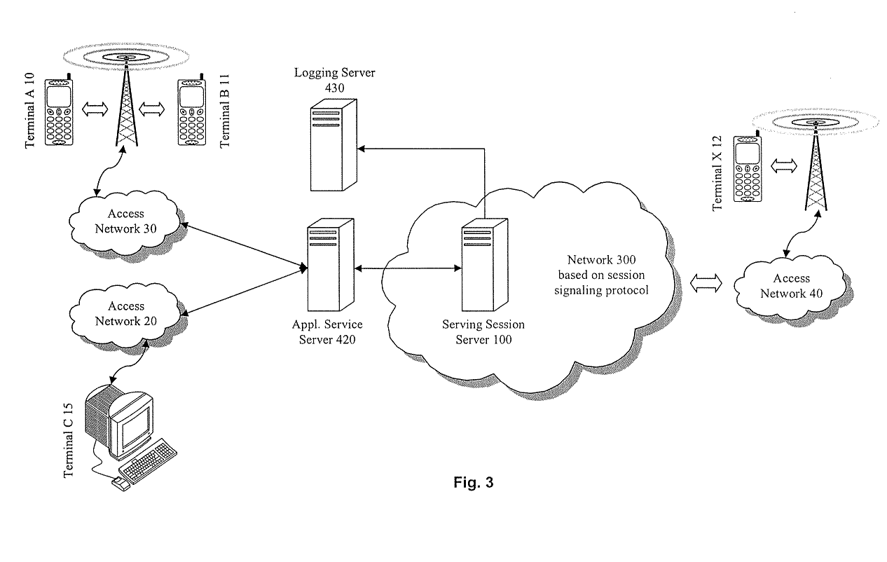

In the following, a more generic exemplary embodiment of the present invention will be described to enlighten core aspects of the present invention. Referring to FIG. 3, the generic exemplary communication system of the present invention comprises a core communication network using a session signaling protocol for negotiating communication sessions between terminal devices. The terminal devices are connected to the core network 300 through any type of access networks 20, 30 and 40. Examples of communication systems and in particular access networks 20, 30, and 40 may include fixed line communication systems, such as a public switched telephone network (PSTN), wireless communication systems, global system for mobile communications (GSM), general packet radio service (GPRS), universal mobile telecommunications system (UMTS), wireless local area network (WLAN) and so on, and any other communication networks, such as an Internet Protocol (IP) network and/or other packet switched data networks.

Various communication systems may simultaneously be concerned in a connection. An end-user may access a communication network by means of any appropriate communication terminal device, such as user equipment (UE), a mobile station (MS), a cellular phone, a personal digital assistant (PDA), a personal computer (PC), or any other equipment operable according to a suitable session signaling network protocol, such as a session initiation protocol (SIP) or a wireless applications protocol (WAP) or a hypertext transfer protocol (HTTP). The user terminal device may support, in addition to call and network access functions, other services, such as short message service (SMS), multimedia message service (MMS), electronic mail (email), Web service interface (WSI) messaging, and voice mail.

The network 300 comprises a serving session server 100 through which all session signaling protocol messages of the terminal devices 10, 11, and 15 are passed. The terminal devices 10, 11, and 15 represent a group of terminal devices in the aforementioned manner. This means, the terminal devices 10, 11, and 15 are used by one end-user and form a terminal device group which makes, for instance, use of converged messaging services performed by the converged services operated at an application providing (Appl.) server 420 interfacing with the serving session server 100. The application providing (Appl.) server 420 may be a network node of the network 300 or may be a network node external to the network 300. Further, a logging or protocol information registering server 430 may also interface with the serving session server 100 and/or the application providing (Appl.) server 420. The logging server 430 offers call session logging services in the manner as defined above.

The terminal device 12 is not part of the end-user's terminal device group exemplarily comprising the terminal devices 10, 11, and 15. The terminal device 12 may be the terminal device of a calling party or a called party.

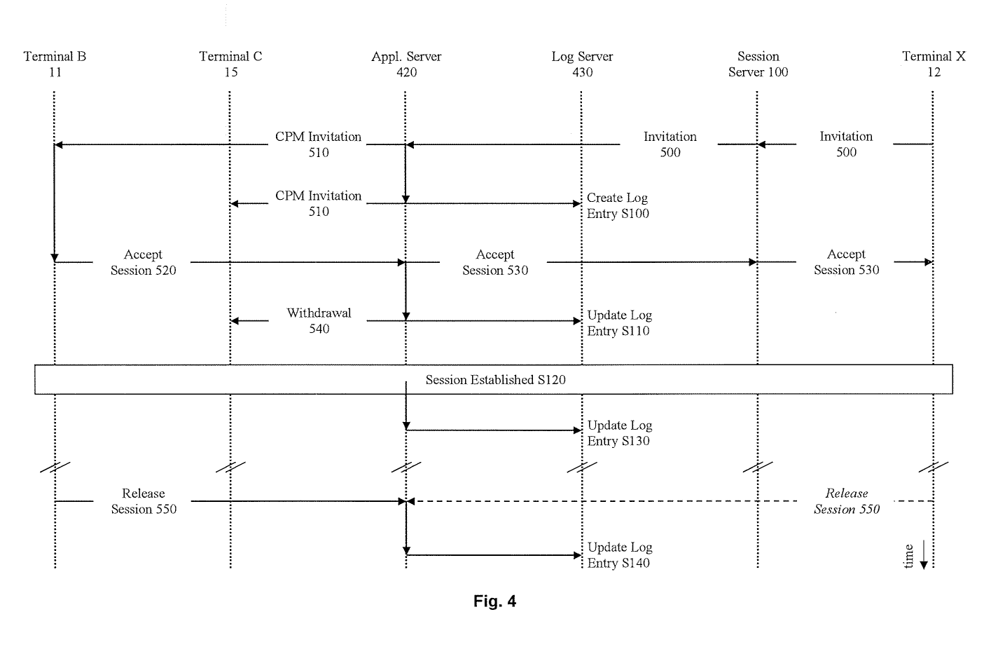

The signaling flow and operation of the different system components of the exemplary embodiment depicted schematically in FIG. 3 will be understood more completely when referring to FIGS. 4 to 6 schematically depicting flow diagrams of messages exchanged between the system components and operations performed by the system components.

It should be understood that the same reference numerals are used to refer to same or similar entities. Similar means that the entities may be similar with respect to their general functions provided and/or supported by the entity. This means that same reference numerals used throughout FIGS. 1 to 6 may refer to different entities, which provide same or similar functions with respect to the core concept of the present invention.

Referring to FIG. 4, the device terminal 12 initiates an invitation request to the terminal device group comprising the terminal devices 10, 11 and 15. The invitation request indicates that the terminal device 12 wishes to establish a session with the user having one of the terminal devices 10, 11 and 15 in the terminal device group. The invitation request may comprise a user related identifier or at least user related information, which can be matched with filtering information (such as initial filter criteria) in order to detect or identify whether converged messaging services applicable to the group of terminal devices 10, 11 and 15 should be offered. The invitation request 500 is routed to the session serving server 100. At the session serving server 100, the invitation request 500 is further routed to the application providing server 420 in accordance with the result of the aforementioned matching operation based on the user related information included in the invitation message. Upon reception of the invitation message at the application providing server 420, the application providing server 420 retrieves device identifiers which identify the respective terminal devices 10, 11, and 15 and ends converged messaging invitations 510 to each of the terminal devices 10, 11, and 15 of the identified group. Herein, it may be assumed that terminal device 10 is switched off or not within the coverage visible to the application providing server 420. Hence, only the terminal devices 11 and 15 receive converged messaging invitations 510 routed thereto. Upon reception of the converged messaging invitations 510 at the terminal devices 11 and 15, the invitation to establish a call session is indicated by the terminal devices 11 and 15 to the end-user thereof. For instance, the terminal devices 11 and 15 may ring.

Now, it should be assumed that the end-user wants to make use of the terminal device 11. For instance, upon the user's actuation of a call accept bottom, the terminal device 11 sends a session acceptance response 520 back to the application providing server 420. The application providing server 420 receives the session acceptance response 520 and issues a session acceptance response 530 to the calling terminal device 12. Subsequently or simultaneously, the application providing server 420 issues a withdrawal notification to the terminal device 15 preventing the terminal device 15 from indicating the request for establishing a call session or showing information about an unanswered call.

The session acceptance response 530 is routed by the serving session server 100 to the calling terminal device 12. Upon reception of the session acceptance response 530 at the terminal device 12, the call session establishment procedure with the terminal device 11 may be continued in an operation S120.

Once the application providing server 420 receives the routed session invitation request, any information about the call available to and/or accessible by the call session logging server 430 can be registered thereat. The call session logging server 430 can generate in an operation S100 a corresponding call protocol entry for the respective session.

Upon reception of a session acceptance response at the application providing server 420, the call protocol information about the current session is updated in an operation S110 by the call session logging server 430. The call protocol information about the current session may be further updated during continued establishment of the session and data exchange during the session in an operation S130. The updating of the call protocol information about the current session may be finally completed in an operation S140, when a session release notification 550 is signaled by one of the terminal devices participating in the call session.

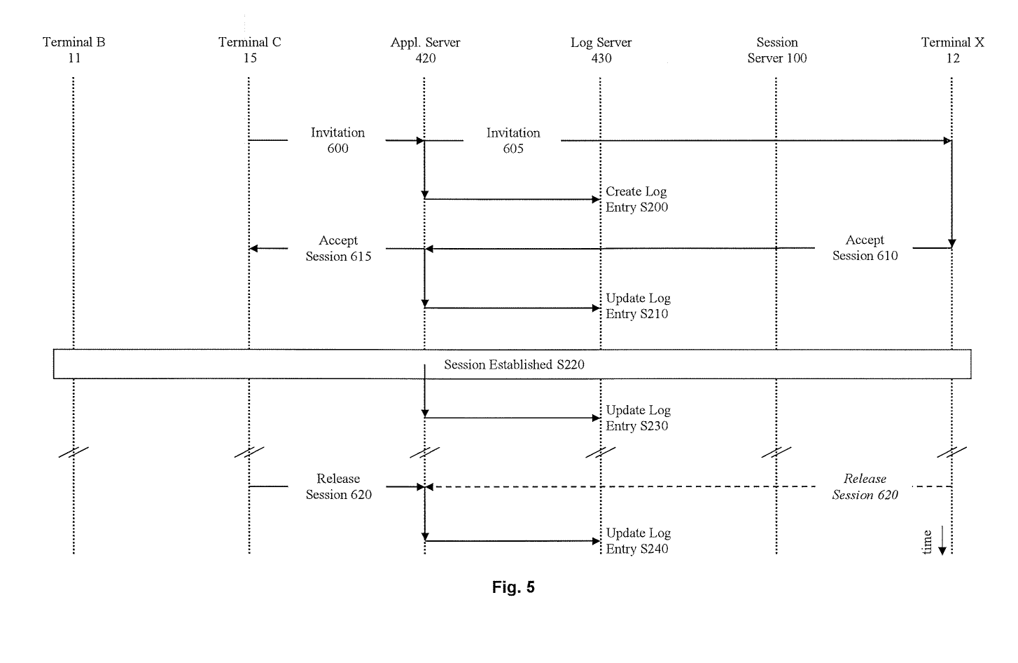

Referring to FIG. 5, logging of call session protocol information may also be enabled, when the device terminal 15, which is one of the grouped terminals, initiates an invitation request to another terminal such as the further terminal 12. The invitation request indicates that the terminal device 15 wishes to establish a session terminal device 12. The invitation request 600 may comprise a terminal device identifier of the terminal device 12 or may comprise an end-user identifier identifying the user of the terminal device 12. In order to enable logging of the call session protocol information, the session invitation request may be issued by the application providing server 420, which issues the session invitation request 605 routed through the serving session server 100 to the terminal device 12.

Upon reception of the session invitation request 605 at the terminal devices 12, the terminal device 12 issues a session acceptance response 610, which is routed through the serving session server 100 to the origin of the session invitation request 605, i.e. the application providing server 420, which upon reception of the session acceptance response 610 informs the originally requesting terminal device 15 by issuing a session acceptance response 615 that is routed to the terminal 15.

The session invitation request 605 and session acceptance response 610 originate and terminate at the application providing server 420, respectively. Hence, the logging of the call session information can be started in an operation S200 when the session invitation request 605 is sent to the terminal device 12 with creating a session protocol entry, which can be updated upon reception of the session acceptance response 610, establishment of the call session and finally upon detection of a session release message signaling issued from one of the participating terminal devices 15 or 12.

Those skilled in the art will understand that the suggested call session protocol logging/registering methodology allows for registering a complete call session protocol including incoming call sessions terminating at any of the group terminal devices and/or outgoing call session originating from any group terminal devices. The complete call session protocol is stored and maintained at the call session logging server 430.

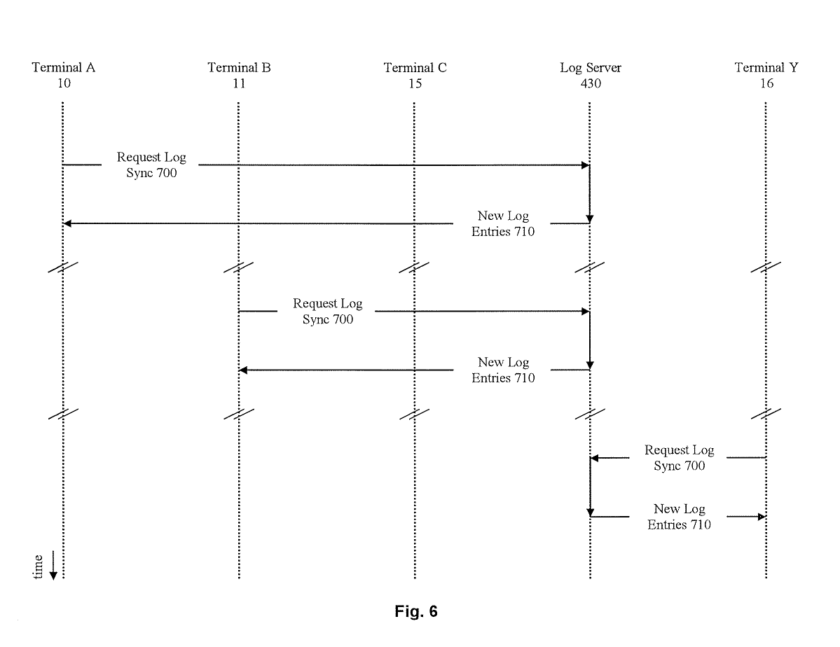

Referring to FIG. 6, any terminal device, which is authorized to access the call session logging server 430 may synchronize its locally stored call session protocol, which may be incomplete due to the use of another terminal device, with the call session logging server. As exemplarily illustrated in FIG. 6, the synchronization may be initiated by the terminal device. Alternatively, the call session logging server 430 may automatically (at a regular or irregular time basis) initiate synchronization with one or more terminal devices. The possibility for synchronization call session protocol information may also not be restricted to the terminal devices 10, 11 and 15 of the group. Any other authorized terminal device such as, for instance, a terminal device 16 or the terminal device 15 may synchronize with the call session protocol information generated on the basis of incoming and/or outgoing calls of the group of terminal devices 10, 11, and 15. For instance, the user may want to maintain a backup of the registered call session protocol information at secured network storage. Backing up of call session protocol information may be required because of legal requirements.

Those skilled in the art will further appreciate the several existing and/or future communication protocol frameworks may be used to enable synchronization between the call session logging server 430 and any terminal device.

The above exemplary embodiments described with reference to FIGS. 4 to 6, are explained to a network implementation an exemplary embodiment of which is described with reference to FIG. 3. Those skilled in the art will appreciate that the invention is not limited to these exemplary embodiments.

In general, the session server 100 is a serving session network node or serving session network function located within a session signaling protocol based network. The application providing server 420 is in general an application service providing network node/function interfacing with the serving session network node/function and hosting and executing application services. The application services providing network node/function is exemplarily embodied as an application service providing network node/function providing converged messaging services. The log server 430, which interfaces at least with the converged messaging server 420 implemented on the basis of the general application services providing node/function, functions in general as a protocol network node/function.

The protocol network node/function registers and protocols any communication session related information.

Moreover, the exemplary network implementation as embodied in FIG. 3 can be implemented on the basis of an IP multimedia subsystem (IMS) architecture as exemplarily embodied in FIG. 1, which may make use of the Open Mobile Alliance (OMA) service architecture (OSE) environment as exemplarily embodied in FIG. 2. Those skilled in the art will appreciate on the basis of the above description that the session server 100 may be implemented as a serving call session control function (S-CSCF) within a session initiation protocol (SIP) based network such as an IP multimedia subsystem (IMS) using session initiation protocol (SIP). The general application services providing network node/function, of which use can be made for implementing converged messaging services, can be realized in a session initiation protocol (SIP) based network such as an IP multimedia subsystem (IMS) by an SIP application server interfacing with the serving session network function such as the serving call session control function (S-CSCF). More particular, the application services providing network node/function supporting converged messaging services may be implemented on the basis of Open Mobile Alliance (OMA) service architecture (OSE) environment. The application services providing network node/function can be implemented as a converged IP messaging (CPM) server/enabler, which may be one server of the shared servers or a part of a message and media storage element in the Open Mobile Alliance (OMA) service architecture (OSE). The general protocol network node/function exemplarily embodied in FIG. 3 as log server 430 may be implemented as call session logging services, which may be realized on the basis of Open Mobile Alliance (OMA) service architecture (OSE) environment. The protocol network node can be implemented as a call log XDM server, which may be one server of the shared XDM servers or a part of a message and media storage element in the Open Mobile Alliance (OMA) service architecture (OSE) or co-located with converged messaging services such as a converged IP messaging (CPM) server/enabler.

Nevertheless, those skilled in the art will understand that the implementation of the present invention on the basis of an IP multimedia subsystem (IMS) operated on a session initiation protocol (SIP) and Open Mobile Alliance (OMA) service architecture (OSE) environment, on the basis of which the exemplary implementation of converged messaging and protocol information registering functionalities has been described, represents only one exemplary implementation of the present invention for the sake of feasibility. The present invention should not be understood as being limited thereto. In particular, the use of the communication session protocol registering and logging function is not limited to being combined with converged messaging services. Other services may also make use of the communication session protocol registering and logging function described above.

From the forgoing description, it will be apparent that modifications can be made to the system without departing from the teachings of the present invention. Accordingly, the scope of the invention is only to be limited as necessarily by the accompanying claims. In particular, alternative, different implementations of the permission table are also possible. The present invention should be understood as not being limited thereto.

1. System, comprising:
a communication network comprising at least a serving session network node, through which communication initiation requests of the communication network are routed;
an application services providing network node interfacing with the serving session network node, wherein the application services providing network node is configured for providing functions related to a group of several terminal devices of a user; and
a protocol network node configured for registering protocol information about a communication session upon reception of a detection signalization indicating the communication initiation request comprising a user related identifier associated with the group of several terminal devices.

2. System according to claim 1, wherein the application services providing network node is configured for detecting the communication initiation and issuing the detection signalization to the protocol network node.

3. System according to claim 1, wherein the application services providing network node is configured for providing multi-terminal communication management based on communication routing criteria.

4. System according to claim 1, wherein the user related identifier comprises at least one out of a group of identifiers including:
any user related information, which allows for identifying the user of the group of several terminal devices and on the basis of which filtering can be performed;
an identifier identifying the group of several terminal devices;
an identifier identifying one terminal device out of the group of several terminal devices; and
an identifier identifying an application service supporting multi-terminal communication management on the basis of communication routing criteria.

5. System according to claim 1, wherein the communication network supports a session signaling protocol supporting indication of initiation of a communication session.

6. System according to claim 5, wherein the session signaling protocol is a session initiation protocol.

7. System according to claim 1, wherein the application services providing network node is configured for issuing one or more individual communication initiation requests to one or more terminal devices out of the group upon receiving the communication initiation request comprising the user related identifier.

8. System according to claim 1, wherein the protocol network node is further configured for storing the protocol information registered thereat, and wherein the protocol network node is also configured for synchronizing protocol information stored thereat with protocol information stored locally in at least one terminal device out of the group of several terminal devices.

9. System according to claim 1, wherein the protocol network node is further configured for notifying at least one terminal device out of the group of several terminal devices about changes to the protocol information.

10. System according to claim 1, wherein the protocol information about the communication session comprises one or more information out of a group of information comprising event status information, date of the call session, time of the call session, duration of the call session, media used during the call session, transport services used during the call session, name of the calling party, address of the calling party, identifier of the calling party, group identifier of the calling parties, and group name.

11. System according to claim 1, wherein said serving session network node is a serving call session control function within a session initiation protocol based IP multimedia subsystem.

12. System according to claim 11, wherein said application services providing network node is a session initiation protocol application server interfacing with the serving call session control function.

13. System according to claim 1, wherein the protocol network node is implemented based on one or more enablers in accordance with Open Mobile Alliance service environment including an extensible markup language document management enabler.

14. Method, comprising
routing communication initiation requests through a serving session network node of a communication network;
detecting a communication initiation request comprising a user related identifier associated with a group of several terminal devices of a user;
upon detection, registering protocol information about a communication session initiated by the communication initiation request comprising the user related identifier at the protocol network node, which interfaces with the serving session network node;
routing the communication initiation request comprising the user related identifier to an application services providing network node; and
providing functions related to the group of several terminal devices.

15. Method according to claim 14, wherein the detecting further comprises:
providing preconfigured filter criteria; and
detecting whether the one or more of the preconfigured filter criteria match with the user related identifier.

16. Method according to claim 14, wherein the detecting of the communication initiation request is performed at the application services providing network node, which issues a detection signalization to the protocol network node.

17. Method according to claim 14, wherein the providing of functions related to the group of several terminal devices comprises providing multi-terminal communication management on the basis of communication routing criteria.

18. Method according to claim 14, further comprising:
issuing one or more individual communication initiations requests to one or more terminal devices of the group of several terminal devices upon receiving the communication initiation request comprising the user related identifier.

19. Method according to claim 14, further comprising:
synchronizing local protocol information in at least one terminal device out of the group of several terminal devices with the protocol information maintained at the protocol network node.

20. Method according to claim 14, further comprising:
notifying at least one terminal device out of the group of several terminal devices about changes to the protocol information maintained at the protocol network node.

21. Method according to claim 14, wherein the protocol information comprises one or more information out of a group of information comprising event status information, date of the call session, time of the call session, duration of the call session, media used during the call session, transport services used during the call session, name of the calling party, address of the calling party, identifier of the calling party, group identifier of the calling parties, group name, and information about the participants in the call session.

22. Computer program product comprising a computer readable medium, which includes instructions, which when carried out on a processor, cause the operations of routing communication initiation requests through a serving session network node of a communication network, wherein the serving session network node interfaces with an application services providing network node and a protocol network node; and
upon detecting that a communication initiation request comprises a user related identifier associated with a group of several terminal devices of a user,
registering protocol information about a communication session initiated by the communication initiation request comprising the user related identifier at the protocol network node; and
routing the communication initiation request comprising the user related identifier to the application services providing network node such that functions related to the group of several terminal devices can be provided thereat.

23. Method, comprising
registering information about a session at a session protocol network node upon detecting a communication initiation request comprising a user related identifier associated with a group of several terminal devices of a user;
wherein the communication initiation request is routed through a serving session network node of a communication network, wherein an application services providing network node and a protocol network node interface with the serving session network node; and
wherein the communication initiation request is routed to the application services providing network node, which is configured for providing functions related to the group of several terminal devices.

24. Computer program product comprising a computer readable medium, which includes instructions, which when carried out on a processor, cause the operations of registering information about a communication session at a session protocol network node upon detecting a communication initiation request comprising a user related identifier associated with identifying a group of several terminal devices of a user;
wherein the communication initiation request is routed through a serving session network node of a communication network, wherein an application services providing network node and a protocol network node interface with the serving session network node; and
wherein the communication initiation request is routed to the application services providing network node, which is configured for providing function related to the group of terminal devices.

25. Apparatus, configured for registering information about a communication session upon detection of a communication initiation request comprising, a user related identifier associated with a group of several terminal devices of a user;
wherein the communication initiation request is routed through a serving session network node of a communication network, wherein an application services providing network node and a protocol network node interface with the serving session network node; and
wherein the communication initiation request is routed to the converged messaging network node, which is configured for providing functions related to the group of several terminal devices.
